(19) United States
(12) Patent Application Publication
(10) Pub. No.: US 2012/0133647 A1
(43) Pub. Date: May 31, 2012

(54) THREE-DIMENSIONAL IMAGE DISPLAY

(76) Inventors: Fung-Hsu WU, Taoyuan County (TW); Hsin Han HSU, Taoyuan County (TW)

(21) Appl. No.: 13/283,028

(22) Filed: Oct. 27, 2011

(30) Foreign Application Priority Data
Nov. 30, 2010 (TW) 099141554

(51) Int. Cl. G06T 15/00

(52) U.S. Cl. 345/419

(57) ABSTRACT

A three-dimensional image display includes a liquid crystal display panel, a lenticular layer, and a backlight module, wherein the lenticular layer is disposed on the liquid crystal display panel to separate images generated by the liquid crystal display panel. The backlight module includes a light emitting device and at least one brightness enhancing film. The liquid crystal display panel accepts light from the backlight module and generates a plurality of images. Prisms and lenses are disposed on the brightness enhancing film and the lenticular layer, respectively, wherein orientations of prisms and lenses cross each other. The three-dimensional image display makes the traveling direction of light more perpendicular to the surface of liquid crystal display panel in order to reduce the crosstalk between adjacent images.

### BACKGROUND OF THE INVENTION

1. Field of the Invention

The present invention relates to a three-dimensional image display, specifically to a three-dimensional image display with reduced image crosstalk.

2. Description of the Prior Art

At present, because of the progresses in display technology and hardware, more and more three-dimensional displays capable of providing three-dimensional visual effect appear in the market, wherein two eyes of the viewer each observes object at different angle, allowing the viewer to identify the distance from the object and enjoy the three-dimensional visual effect. The three-dimensional displays utilize the principle mentioned above and separate images into left eye images and right eye images in order to provide three-dimensional visual effect. Previously, viewers need to wear special glasses designed with different colored lenses or different polarizing filters in order to separate images generated by the three-dimensional display into left eye images and right eye images. However, the lenticular lens technology allows the three-dimensional display to separate images through the lenticular lens provided therein, so that the viewer need not to wear special glasses and can view different images for left eye and right eye to enjoy the three-dimensional visual effect.

FIG. 1 is a cross-sectional view of a conventional three-dimensional flat display 10. The conventional three-dimensional flat display 10 includes a liquid crystal display panel 20 and a lenticular layer 30, wherein the lenticular layer 30 is disposed on the surface of liquid crystal display panel 20 and includes a plurality of lenticular lenses 31. The liquid crystal display panel 20 includes a plurality of pixel units 21, 22, 23, 24, and 25 for generating a plurality of images V1, V2, V3, V4, and V5. As FIG. 1 shows, the lenticular lenses 31 change the orientations of the images V1, V2, V3, V4, and V5 so that two images of images V1, V2, V3, V4, and V5 can be received by the left eye 40 and right eye 41 of the viewer, respectively. In this way, the viewer can enjoy three-dimensional visual effect without wearing glasses.

However, even if the images V1, V2, V3, V4, and V5 are separated by the lenticular lenses 31, a portion of adjacent images of images V1, V2, V3, V4, and V5 can still overlap each other. For instance, the left eye 40 of the viewer can observe the image V3 as well as a portion of the images V2, V4. On the other hand, the right eye 41 of the viewer will receive the image V2 as well as a portion of the images V1, V3. In this way, the vision system of the viewer is unable to generate the desired three-dimensional visual effect due to the overlapping of left eye images and right eye images. Therefore, one of the important topics in three-dimensional flat display is how to effectively separate the images V1, V2, V3, V4, and V5 while maintaining the overall structure of the liquid crystal display panel 20.

### SUMMARY OF THE INVENTION

It is an object of the present invention to provide a three-dimensional image display which manipulates the angle between the orientation of lens of a lenticular layer and the orientation of prisms of a brightness enhancing film to reduce the crosstalk between left-eye images and right-eye images generated by the three-dimensional image display.

The three-dimensional image display of the present invention includes a display panel, a lenticular layer, and a backlight module, wherein the backlight module includes a casing, a reflector, a light emitting device, a first diffusion film, a second diffusion film, and a brightness enhancing film. Light generated by the light emitting device passes through the first diffusion film, the second diffusion film, and the brightness enhancing film and then moves toward the display panel. The lenticular layer is disposed on one side of the display panel facing away from the backlight module for divides the images generated by the display panel into left-eye images and right-eye images.

The surface of the brightness enhancing film has prisms disposed thereon to change the traveling direction of light and reflect a portion of light back to the brightness enhancing film so that the traveling direction of the light can be substantially perpendicular to the surface of the display panel. By changing the angle between the orientation of lenses of the lenticular layer and the orientation of prisms of the brightness enhancing film, the left-eye image is effectively separated from the right-eye image. In this way, the viewer will not experience unacceptable visual effect because the left eye accepts only left-eye images and the right eye accepts only right-eye images.

In different embodiments, the three-dimensional image display of the present invention includes a first brightness enhancing film and a second brightness enhancing film, wherein the first brightness enhancing film includes a plurality of first prisms and the second brightness enhancing film includes a plurality of second prisms. The orientation of the first prisms and the orientation of the second prisms intersect and an angle exists between the orientation of the first prisms and the orientation of the second prisms, wherein the three-dimensional image display uses the arrangement of the first lens and the second lens to make the traveling direction of light more perpendicular to the surface of the display panel to separate images adjacent to each other.

### BRIEF DESCRIPTION OF THE DRAWINGS

FIG. 1 is a cross-sectional view of a conventional three-dimensional flat display;

FIG. 2 is an exploded view of the three-dimensional image display of the present invention;

FIG. 3 is another exploded view illustrating the light path in the three-dimensional image display of FIG. 2;

FIG. 4A is a top view illustrating the brightness enhancing film and the lenticular layer of the present invention;

FIG. 4B is a diagram illustrating the light field distribution for the left eye image and the right eye image generated by the three-dimensional image display of FIG. 2;

FIG. 5A is a top view illustrating a variation embodiment of the brightness enhancing film and the lenticular layer of the present invention;

FIG. 5B is a diagram illustrating the light field distribution of the three-dimensional image display in the variation embodiment of FIG. 5A;

FIG. 6A is an exploded view illustrating a variation embodiment of the three-dimensional image display illustrated in FIG. 2;

FIG. 6B is a top view illustrating the lenticular layer, the first brightness enhancing film, and the second brightness enhancing film in the embodiment of FIG. 6A;

FIG. 6C is a schematic view illustrating the light path in the three-dimensional image display of FIG. 6A; and

FIG. 7 is a diagram illustrating the light field distribution of the three-dimensional image display illustrated in FIG. 6A, FIG. 6B, and FIG. 6C.

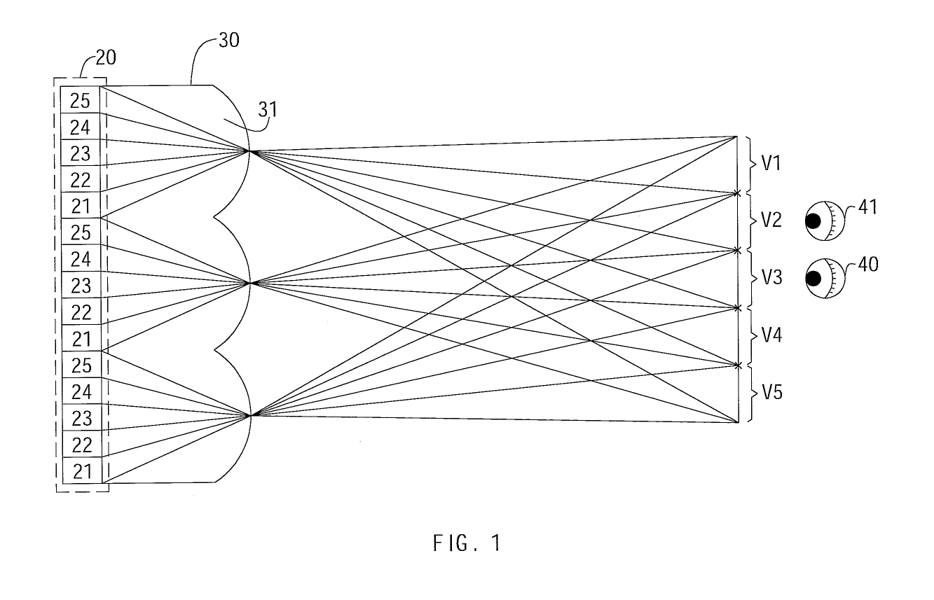

### DETAILED DESCRIPTION OF THE PREFERRED EMBODIMENT

The present invention relates to a three-dimensional image display whereas the three-dimensional image display does not require the viewer to wear a pair of three-dimensional glasses to experience three-dimensional visual effect. The three-dimensional image display includes a display panel, a lenticular layer, and a backlight module, wherein the backlight module includes a brightness enhancing film to increase the overall brightness of backlight. By means of image alignment and image-splitting function of the lenticular layer, the left eye and right eye of the viewer can receive a left-eye image and a right-eye image, respectively, so that a three-dimensional image is provide to the viewer. Furthermore, the three-dimensional image display reduces the divergence of light from the backlight module by adjusting the angle between the prism of the brightness enhancing film and the lenses of the lenticular layer so as to reduce the crosstalk between the left-eye image and the right-eye image.

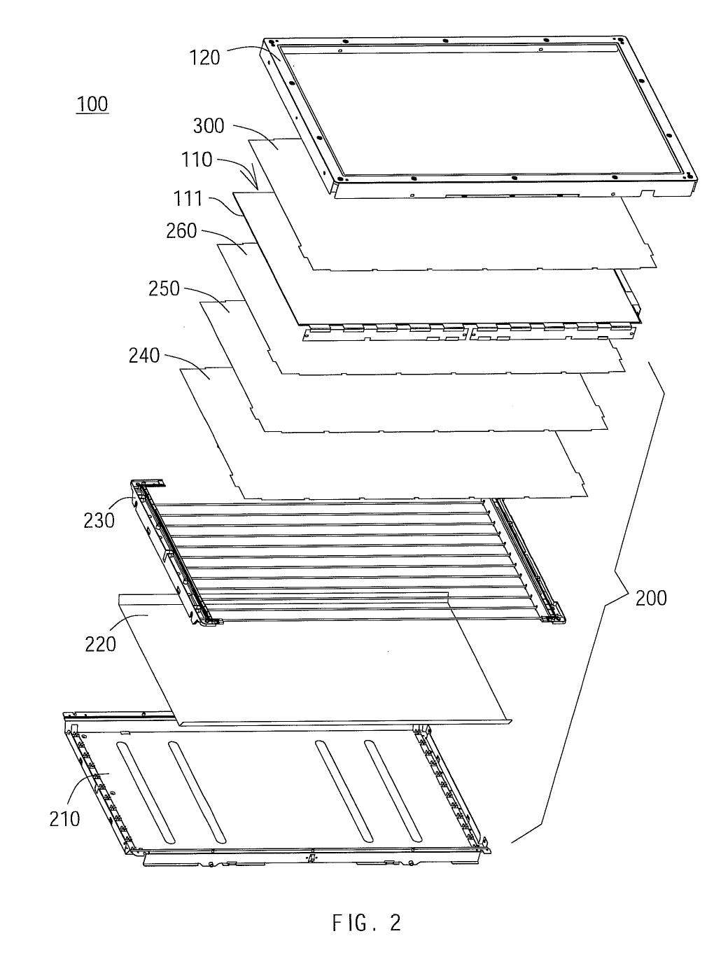

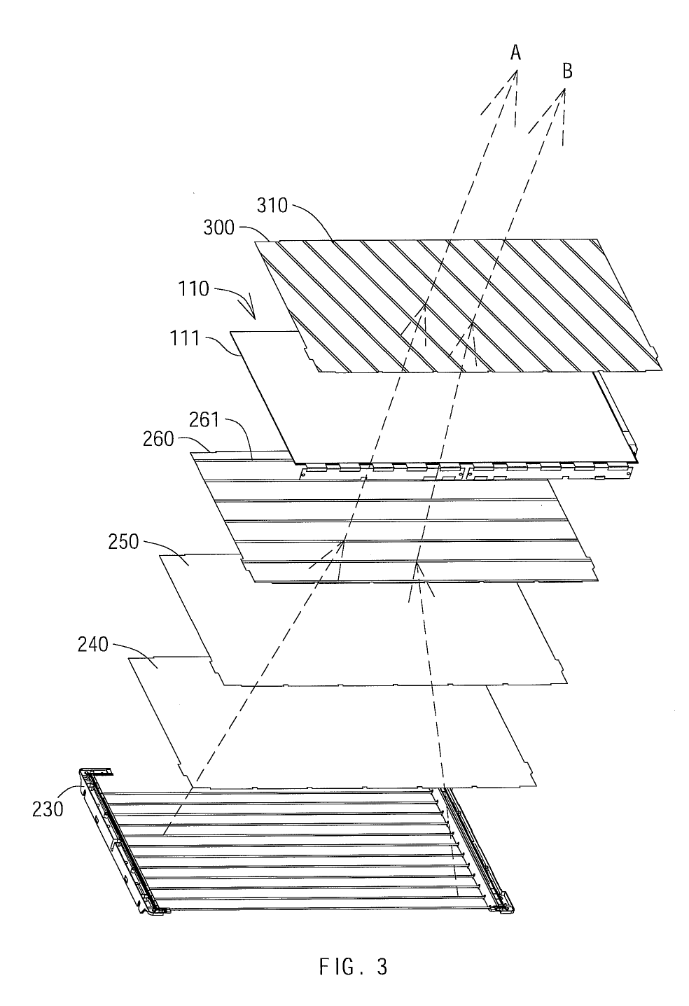

FIG. 2 is an exploded view of the three-dimensional image display 100 while FIG. 3 is another exploded view illustrating the light path in the three-dimensional image display 100. As FIG. 2 and FIG. 3 show, in the present embodiment, the three-dimensional image display 100 includes a liquid crystal display panel 110, a liquid crystal display panel frame 120, a backlight module 200, and a lenticular layer 300, wherein the lenticular layer 300 includes a plurality of lenses 310 disposed thereon and parallel with each other. Light generated by the backlight module 200 passes through the liquid crystal display panel 110 so that the liquid crystal display panel 110 can create images emerging from the opening of the liquid crystal display panel frame 120. The backlight module 200 includes a casing 210, a reflector 220, a light emitting device 230, a first diffusion film 240, a second diffusion film 250, and a brightness enhancing film 260. The light emitting device 230 of the present embodiment includes a plurality of cold cathode fluorescent lamp (CCFL), but is not limited thereto; in different embodiments, the light emitting device 230 may include a plurality of light emitting diodes (LEDs) in a light bar form or other conventional light emitting elements.

Light emitted by the light emitting device 230 passes through the first diffusion film 240, the second diffusion film 250, the brightness enhancing film 260 and then moves toward the liquid crystal display panel 110, wherein the brightness enhancing film 260 controls the traveling direction of light through reflection and refraction, so that the light evenly distributed by the diffusion films converges within the viewing angle of the viewer. Since the light converges within the viewing angle of the viewer, the brightness enhancing film 260 increases the overall brightness of images generated by the three-dimensional image display 100.

As FIG. 3 shows, in the present embodiment, the brightness enhancing film 260 has a plurality of prisms 261, wherein the prisms 261 are configured to reflect part of the light that runs away from the viewing range back to the brightness enhancing film 260. The part of light is then reflected at the brightness enhancing film 260 and eventually exits the brightness enhancing film 260 from a direction within the viewing angle. In other words, the prisms 261 are used to recycle light outside the viewing angle and change its traveling direction so as to increase the amount of light within the viewing angle and the light intensity perceived by the viewer. Lights A, B generated by the light emitting device 230 are refracted by the prisms 261 and subsequently move in a direction substantially perpendicular to the surface plane of brightness enhancing film 260. Lights A and B are substantially parallel with each other and thus images generated by the liquid crystal display panel 110 with lights A and B and received by the viewer do not cross each other, i.e. do not overlap. In this way, the vision system of the viewer is less likely to be subject to uncomfortable visual experience due to the overlapping of images. Furthermore, the arrangement of the prisms 261 and the lens 310 in cross-orientation of a certain angle allows more effective separation of images generated by the liquid crystal display panel 110.

Each of the lenses 310 disposed on the surface of the lenticular layer 300 has a curved surface used to separate images generated by the liquid crystal display panel 110. In this way, the left eye and right eye of a viewer can respectively receive only corresponding left eye images and corresponding right eye images generated by the three-dimensional image display 100 to experience the three-dimensional visual effect.

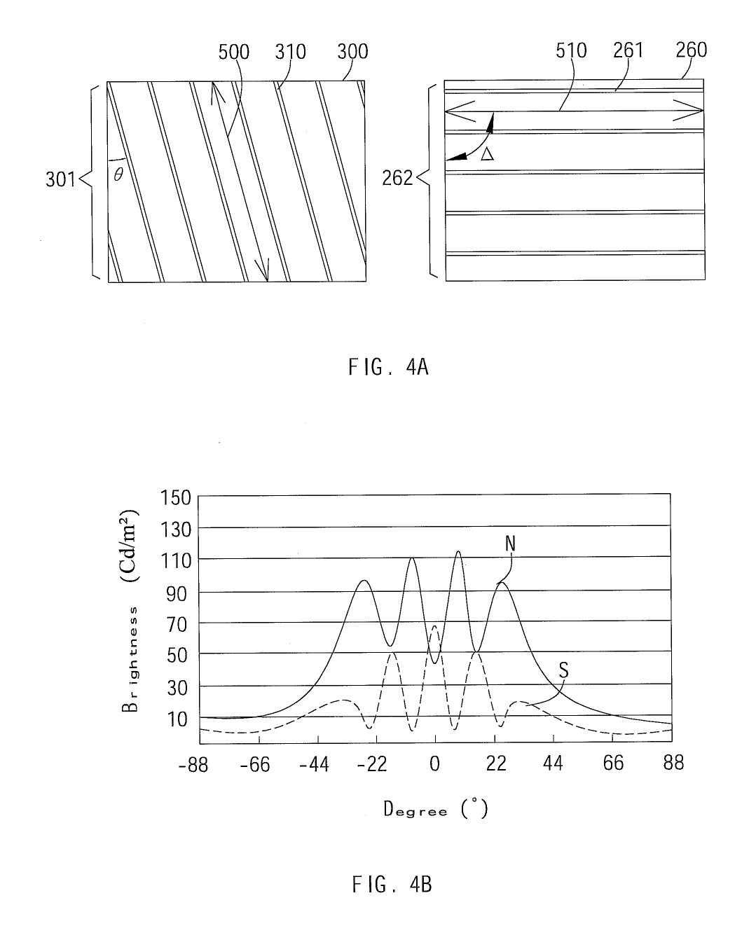

FIG. 4A is a top view illustrating the brightness enhancing film 260 and the lenticular layer 300 of FIG. 2. FIG. 4B is a diagram illustrating the light field distribution for left eye image and right eye image generated by the three-dimensional image display 100. As FIG. 4A shows, the lenses 310 of the lenticular layer 300 are formed mutually in parallel on the surface of the lenticular layer 300. The lenses 310 have a first orientation 500, wherein a reference angle θ exists between the first orientation 500 and the extending direction of the lateral side 301 of lenticular layer 300. The lateral side of lenticular layer 300 is parallel with two shorter sides of the liquid crystal display panel 110 of FIG. 3 and therefore the angle between the first orientation 500 and the shorter sides of the liquid crystal display panel 110 is also the reference angle θ.

The reference angle θ of the present embodiment is preferably 18.43°, so that the lenses 310 formed on the surface of lenticular layer 300 are oblique with respect to the lateral side 301 of the lenticular layer 300, but are not limited thereto. In different embodiments, the reference angle θ can be other angle as appropriate.

In the present embodiment, the prisms 261 formed on the brightness enhancing film 260 are mutually in parallel. The prism 261 has a second orientation 510, wherein a first angle □ exists between the second orientation 510 and the extending direction of the lateral side 262 of the brightness enhancing film 260. The lateral side 262 of the brightness enhancing film 260 is parallel with two shorter sides of the liquid crystal display panel 110, and therefore the angle exists between the second orientation 510 and the shorter side of the liquid crystal display panel 110 is also the first angle □. In the present embodiment, the first angle □ is substantially 90°, but is not limited thereto. In addition, an angle also exists between the first orientation 500 of the lenses 310 and the second orientation 510 of the prisms 261, wherein the angle in the present embodiment is preferably 71.57°, but is not limited thereto.

Here please refer to the light field distribution diagram in FIG. 4B. As FIG. 4B shows, the X-axis represents the angle between the line of sight of the viewer and the normal line of the display plane of the three-dimensional image display 100. Moreover, the Y-axis in FIG. 4B represents the light field intensity in the visual images generated by the three-dimensional image display 100, wherein the value on the Y-axis represents the relative intensity of light field. The three-dimensional image display 100 of the present embodiment outputs 5 images, wherein each image renders different light field intensity with respect to the viewer at different viewing angle. Since the three-dimensional image display 100 provides the viewer at the center of viewing angle with better visual effect, detailed discussions are provided for the center of viewing angle, i.e. 0° shown in FIG. 4B. Furthermore, in different embodiments, the three-dimensional image display 100 can output other number of visual images.

In the embodiment illustrated in FIG. 4B, the target curve S represents the light field intensity of one of the 5 images generated by the three-dimensional image display 100, wherein the target curve S represents the image generated by the three-dimensional image display 100 for the viewing angle of 0°. On the other hand, the reference curve N in FIG. 4B represents the sum of light field intensity of 4 other images generated by the three-dimensional image display 100. In other words, the reference curve N represents images corresponding to other viewing angles. As FIG. 4B shows, the intensity of the target curve S is greater than the intensity of the reference curve N at 0°. In other words, the light field intensity of the image corresponding to the target curve S at 0° is greater than the light field intensity of other images at 0°, wherein the ratio of intensity of the two curves is substantially 1.47:1.

Furthermore, in the embodiments illustrated in FIG. 4A and FIG. 4B, the overall brightness of three-dimensional image display 100 is preferably 66 cd/m², wherein the above-mentioned brightness will be used as a reference in the embodiments explained below.

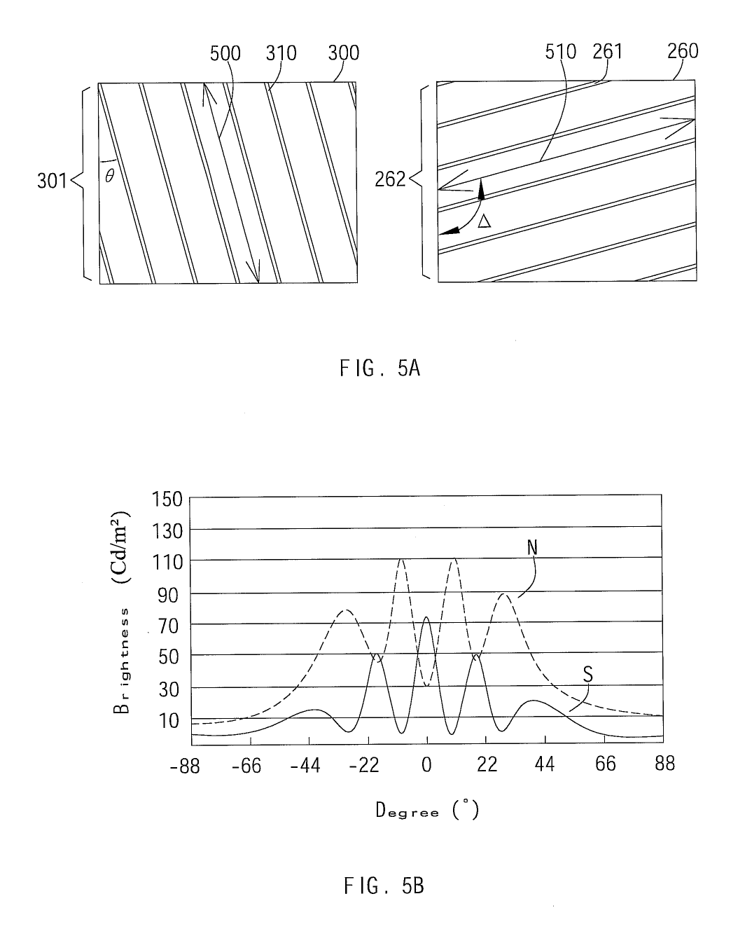

FIG. 5A is a top view illustrating a variation embodiment of the brightness enhancing film 260 and the lenticular layer 300 in FIG. 2. FIG. 5B is a diagram illustrating the light field distribution of the three-dimensional image display 100 of the present embodiment. As FIG. 5A shows, the lenses 310 of the lenticular layer 300 are formed mutually in parallel on the surface of the lenticular layer 300, whereas a reference angle θ exists between the first orientation 500 and the lateral side 301 of the lenticular layer 300. In the present embodiment, the reference angle θ is preferably 18.43°. In addition, the prisms 261 on the brightness enhancing film 260 are oblique with respect to the lateral side 262, wherein the second orientation 510 of the prisms 261 is perpendicular to the first orientation 500 of the lenses 310. In other words, an angle of 90° exists between the first orientation 500 and the second orientation 510. The first angle □ exists between the second orientation 510 and the shorter side of the three-dimensional image display 100, and the lateral side 262 of the brightness enhancing film 260 is parallel with the shorter side of the three-dimensional image display 100. Therefore the first angle □ also exists between the second orientation 510 and the shorter side of the three-dimensional image display 100. In the present embodiment, the first angle □ is substantially (90°+θ), but is not limited thereto. In different embodiments, the first angle □ can be adjusted between (70°+θ) and (110°+θ). In more preferred embodiments, the first angle □ is adjusted between (80°+□) and (100°+θ). Except for the first angle □, the three-dimensional image display 100 of the present embodiment is substantially identical to the embodiment of FIG. 2 and thus will not be further elaborated here.

Please refer to the light field distribution diagram in FIG. 5B. As FIG. 5B shows, the image corresponding to the target curve S at 0° has a light field intensity greater than the light field intensity of the image corresponding to the reference curve N at 0°. The ratio of light field intensity of the image corresponding to the target curve S and the image corresponding to the reference curve N is substantially 2.42:1. In this way, the image corresponding to the target curve S is less distorted by other images. Therefore, the viewer at the center of viewing angle of the three-dimensional image display 100 is subjected to less image crosstalk. This shows that the three-dimensional image display 100 can reduce the crosstalk between left eye images and right eye images by modifying the angle between the first orientation 500 and the second orientation 510.

Furthermore, in the embodiments illustrated in FIG. 5A and FIG. 5B, the overall brightness generated by the three-dimensional image display 100 is substantially 73.3 cd/m². The overall brightness of three-dimensional image display 100 of the present embodiment is substantially 10% greater than the overall brightness generated by the three-dimensional image display 100 illustrated in FIG. 4A. This shows that the three-dimensional image display 100 illustrated in FIG. 5A increases the overall brightness and reduces image crosstalk by adjusting the angle between the first orientation 500 of the lenses 310 and the second orientation 510 of the prisms 261.

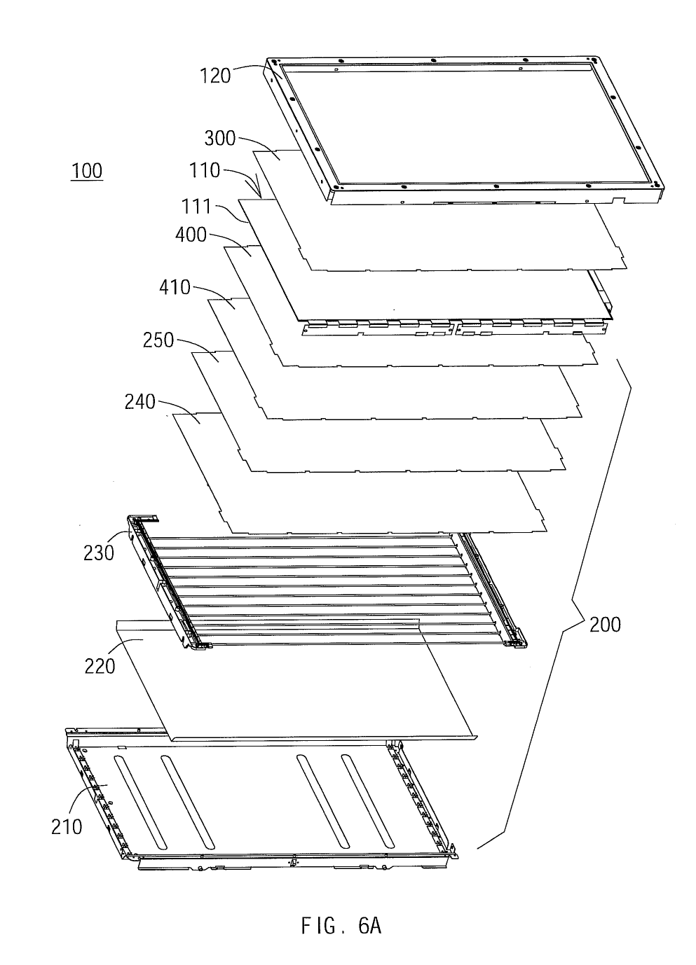

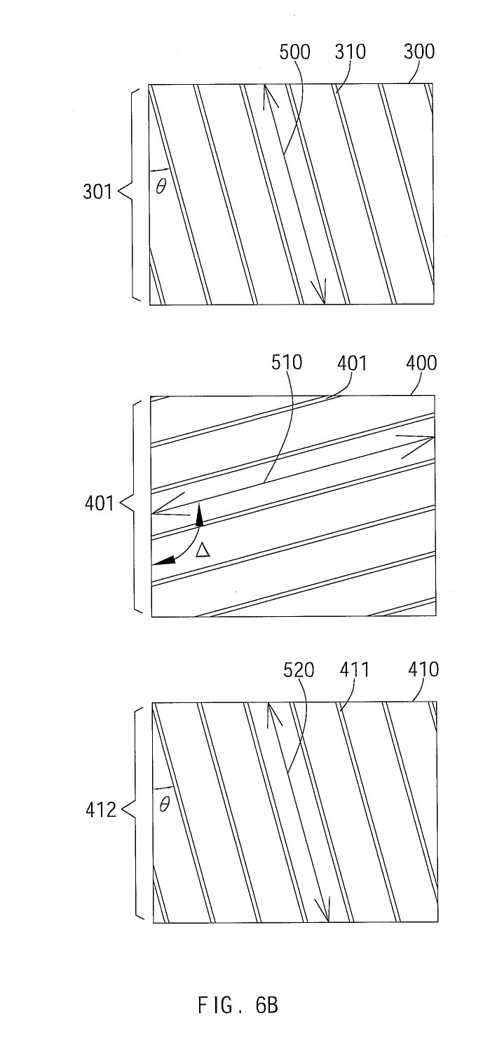

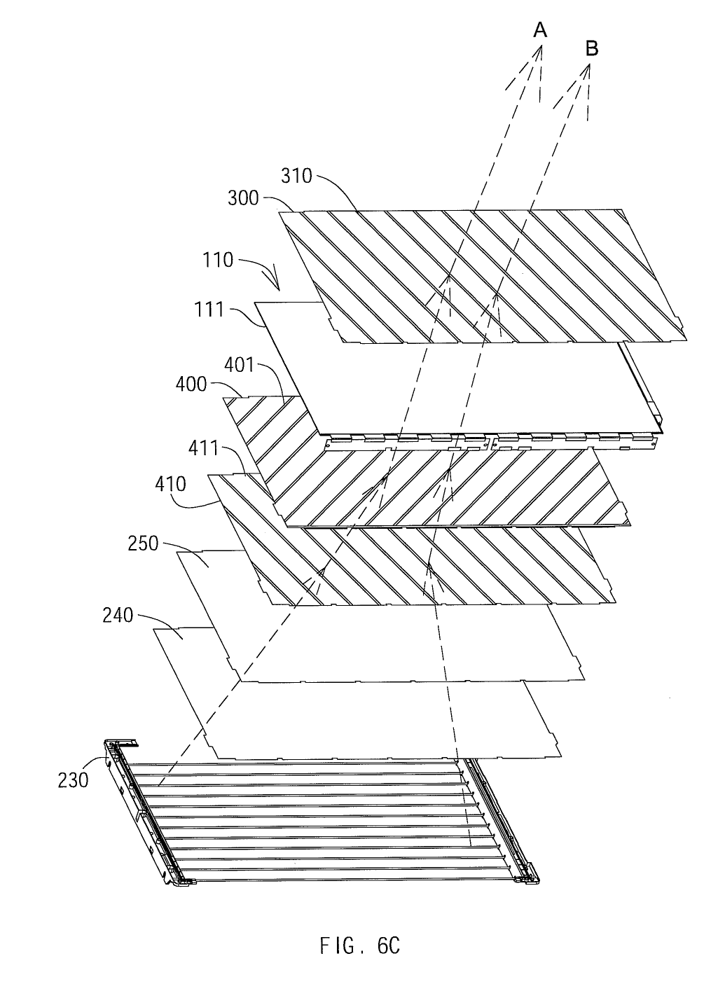

FIG. 6A is a schematic view illustrating a variation embodiment of the three-dimensional image display 100 illustrated in FIG. 2. As FIG. 6A shows, the three-dimensional image display 100 of the present embodiment includes a first brightness enhancing film 400 and a second brightness enhancing film 410 disposed between the first brightness enhancing film 400 and the second diffusion film 250. Furthermore, the first brightness enhancing film 400 includes a plurality of first prism 401 formed thereon whereas the second brightness enhancing film 410 includes a plurality of second prisms 411 formed thereon. In this way, orientations of light generated by the light emitting device 230 will be refracted by the first prisms 401 and then refracted again by the second prisms 411 so that the light can be further concentrated within the viewing angle of the viewer. Thus the three-dimensional image display 100 of the present embodiment further increases the overall brightness by using the second brightness enhancing film 410.

FIG. 6B is a top view illustrating the lenticular layer 300, the first brightness enhancing film 400, and the second brightness enhancing film 410. The lenticular layer 300 of the present embodiment is substantially identical to the lenticular layers illustrated in FIG. 4A and FIG. 5A, wherein the lenses 310 are formed mutually in parallel on the surface of the lenticular layer 300. In addition, the reference angle θ exists between the lateral side 301 of the lenticular layer 300 and the first orientation 500 of the lens 310, wherein the reference angle θ of the present embodiment is preferably 18.43°.

In the present embodiment illustrated in FIG. 6B, the second orientation 510 of the first prism 401 is identical to that illustrated in FIG. 5A. The distance between the first prisms 401 in FIG. 6A is substantially equal to those illustrated in FIG. 5A. In other words, the first brightness enhancing film 400 illustrated in FIG. 6B is substantially identical to the brightness enhancing film 260 illustrated in FIG. 5A. Therefore, the second orientation 510 of the first prism 401 is substantially perpendicular to the first orientation 500 of the lenses 310. That is, an angle of 90° exists between the first orientation 500 of lenses 310 and the second orientation 510 of the first prisms 401. A first angle □ exists between the second orientation 510 of the prisms 401 and the lateral side 401 of the first brightness enhancing film 400. The lateral side 401 of the first brightness enhancing film 400 is parallel with the shorter side of the liquid crystal display panel 110 illustrated in FIG. 6A. Therefore, the first angle □ also exists between the second orientation 510 of the first prisms 401 and the shorter side of the liquid crystal display panel 110. In the present embodiment, the first angle □ is preferably (90°+θ), but is not limited thereto; in different embodiments, the first angle □ can be adjusted between (70°+θ) and (110°+θ). In more preferred embodiments, the first angle □ is adjusted between (80°+θ) and (100°+θ).

As FIG. 6B shows, the third orientation 520 of the second prisms 411 on the second brightness enhancement film 410 is substantially perpendicular to the second orientation 510 of the first prisms 401 on the first brightness enhancing film 400. In other words, the third orientation 520 of the second prisms 411 on the second brightness enhancing film 410 is substantially parallel with the first orientation 500 of the lenses 310 on the lenticular layer 300. In the present embodiment, the second orientation 510 of the first prisms 401 and the third orientation 520 of the second prisms 411 are preferably perpendicular to each other, but are not limited thereto. In different embodiments, an angle other than 90° can exist between the second orientation 510 of the first prisms 401 and the third orientation 520 of the second prisms 411, e.g. an angle between 45° and 90°.

FIG. 6C is a schematic view illustrating the light path in the three-dimensional image display 100 in FIG. 6A. As FIG. 6C shows, light generated by the light emitting device 230 enters from one side of the second brightness enhancing film 410 and eventually exits through one side of the first brightness enhancing film 400 that faces away from the second brightness enhancing film 410. As FIG. 6C shows, the first prisms 401 further refract light exiting the second prisms 411 so that the light exiting the first brightness enhancing film 400 can travel in a direction perpendicular to the surface of lenticular layer 300.

Furthermore, the first prisms 401 on the surface of first brightness enhancing film 400 accepts light from the second brightness enhancing film 410 and reflects the light back to the first brightness enhancing film 400. In this way, the first brightness enhancing film 400 can refract those lights from the second brightness enhancing film 410 so that more light can exit the first brightness enhancing film 400 and travels in a direction perpendicular to the surface of the liquid crystal display panel 110. In other words, the first prisms 401 can recycle light which would have been lost, so that more light can travel in a direction perpendicular to the liquid crystal display panel 110 and be received by the viewer's eyes. In this way, the overall brightness generated by the three-dimensional image display 100 of the present embodiment is greater than that generated by the three-dimensional image display 100 implemented with only one brightness enhancing film.

Furthermore, in the embodiment illustrated in FIG. 6C, lights eventually travels in a direction perpendicular to the surface of the first brightness enhancing film 400 and therefore lights A and B do not intersect with each other. Images generated by the liquid crystal display panel 110 using lights A and B will not intersect with each other and images received by the viewer's eyes will not overlap. In this way, the vision system of the viewer is less likely to be subjected to undesired visual effect induced by overlapping images.

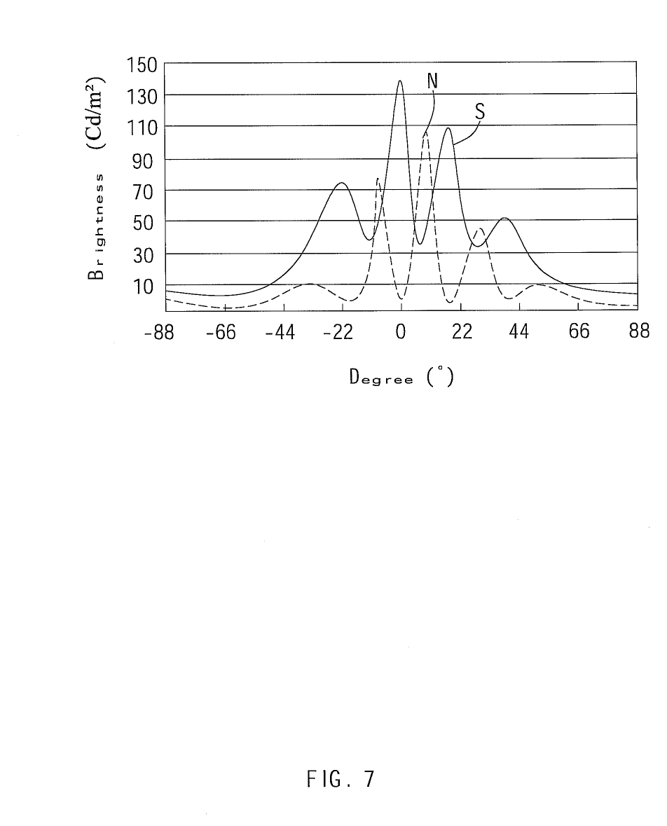

FIG. 7 is a light field distribution diagram of the three-dimensional image display 100 illustrated in FIG. 6A, FIG. 6B, and FIG. 6C. As FIG. 7 shows, the brightness of the target curve N at 0° is greater than that of the reference curve S at 0°. In other words, the light field intensity of the image corresponding to the target curve S is greater than the light field intensity of other images, wherein the ratio of the light field intensities is substantially 3.19:1.

The three-dimensional image display 100 illustrated in FIG. 6A uses a plurality of prisms with intersecting orientations to reduce image crosstalk and increase the overall brightness of the three-dimensional image display 100. The overall brightness of the three-dimensional image display 100 of the present embodiment is substantially 104.9 cd/m². It shows that the overall brightness generated by the three-dimensional image display 100 of FIG. 6A is approximately 57.5% greater than that of the three-dimensional image display 100 illustrated in FIG. 4A.

Furthermore, the three-dimensional image display 100 of the present embodiment uses the first brightness enhancing film 400 and the second brightness enhancing film 410 to process lights generated by the light emitting device 230, but is not limited thereto. In different embodiments, the three-dimensional image display 100 can use other number of brightness enhancing films or brightness enhancing films having different optical characteristics based on criterions such as luminous intensity of the light emitting device 230 and optical characteristics of brightness enhancing films.

The above is a detailed description of the particular embodiment of the invention which is not intended to limit the invention to the embodiment described. It is recognized that modifications within the scope of the invention will occur to a person skilled in the art. Such modifications and equivalents of the invention are intended for inclusion within the scope of this invention.

What is claimed is:

1. A three-dimensional image display, comprising:
a display panel;
a lenticular layer including a plurality of lenses disposed on a first surface of the display panel, wherein the lens has a first orientation; and
a backlight module including at least one first brightness enhancing film disposed on a second surface of the display panel opposite to the lenticular layer, wherein the first brightness enhancing film includes a plurality of first prisms having a second orientation;
wherein a reference angle θ exists between the first orientation of the lens and a first side of the display panel, a first angle exists between the second orientation of the first prism and the first side of the display panel and the first angle is between (70+θ)° and (110+θ)°.

2. The three-dimensional image display of claim 1, wherein the first angle is between (80+θ)° and (100+θ)°.

3. The three-dimensional image display of claim 1, wherein the first angle is substantially (90+θ)°.

4. The three-dimensional image display of claim 1, further comprising a second brightness enhancing film disposed at one side of the first brightness enhancing film opposite to the display panel, wherein the second brightness enhancing film includes a plurality of second prisms having a third orientation perpendicular to the second orientation.

5. The three-dimensional image display of claim 1, wherein the lens is a cylindrical lens.

6. A three-dimensional image display, comprising:
a display panel;
a lenticular layer including a plurality of lenses disposed on a first surface of the display panel, wherein the lens has a first orientation; and
a backlight module including at least a first brightness enhancing film and a second brightness enhancing film disposed at a second surface of the display panel opposite to the lenticular layer, wherein the first brightness enhancing film includes a plurality of first prisms having•a second orientation, the second brightness enhancing film includes a plurality of second prisms having a third orientation;
wherein a reference angle θ exists between the first orientation of the lens and a first side of the display panel, a first angle exists between the second orientation of the first prism and the first side of the display panel, the first angle is between (70+θ)° and (110+θ)°, a second angle exists between the second orientation of the first prism and the third orientation of the second prism whereas the second angle is substantially between 45° and 90°.

7. The three-dimensional image display of claim 6, wherein the first angle is between (80+θ)° and (100+θ)°.

8. The three-dimensional image display of claim 6, wherein the first angle is substantially between (90+θ)°.

9. The three-dimensional image display of claim 6, wherein the second orientation of the first prism and the third orientation of the second prism are substantially perpendicular to each other.

10. The three-dimensional image display of claim 6, wherein the lens is a cylindrical lens.
